(19) United States
(12) Patent Application Publication
(10) Pub. No.: US 2011/0259550 A1
(43) Pub. Date: Oct. 27, 2011

(54) WIND-PRESSURE SHUTTER AND COOLING FAN SYSTEM

(75) Inventors: SHINJI KOMABA, Yokohama (JP); Nobuhiro Tamayama, Yokohama (JP)

(73) Assignee: Hitachi, Ltd.

(21) Appl. No.: 13/072,232

(22) Filed: Mar. 25, 2011

(30) Foreign Application Priority Data
Apr. 26, 2010 (JP) 2010-100871

(51) Int. Cl. F28F 13/00; F16K 15/00

(52) U.S. Cl. 165/96; 137/527

(57) ABSTRACT

Plural flaps provided in a wind-pressure shutter are located approximately parallel to a direction of an airflow path, i.e., the airflow path is opened. Thus, the wind-pressure loss of cooling wind passing through the shutter can be reduced to near zero during the normal operation of the fan. If an air-backflow flows from the exhaust vent due to a fan failure, the flap slightly inclined toward the airflow path receives wind pressure of the air-backflow on its surface, thereby swings about the support shaft to close the airflow path.

### CLAIM OF PRIORITY

The present application claims priority from Japanese patent application serial no. 2010-100871, filed on Apr. 26, 2010, the content of which is hereby incorporated by reference into this application.

### BACKGROUND OF THE INVENTION

The present invention relates to a wind-pressure shutter and a cooling fan system and, more particularly, to a wind-pressure fan and a cooling fan system having plural cooling fans and used in electronic equipment.

Recent rapid advances in computerization have led to a common practice of continuously operating electronic equipment such as communication devices, computers, servers and the like for 24 hours a day. As a result, if the equipment goes out of control, it will cause a great deal of inconvenience to customers.

On the other hand, a housing of the equipment is increasingly reduced in size and space. As a result, heat-producing components are densely packed in the housing. In order to prevent a temperature rise in the housing from making the equipment inoperable to lead to service shutdown, most of the electronic equipment is equipped with plural cooling fans to ensure its redundancy.

FIG. 1A shows an electronic device with plural cooling fans 1. It makes no difference to place the device in a vertical or a horizontal position. In normal operation, cooling wind enters a device housing 3 from an air intake 2, cools a cooled electronic component 4, and then exits from an exhaust vent 5. That is, cooling wind flows as shown by the arrows A. However, if a failure occurs in the cooling fan 1-2 and causes it to stop as shown in FIG. 1B, a flow of cooling wind as shown by the arrows B, which does not travel through the cooled electronic component 4, takes place in addition to the flow shown by the arrow A′. As a result, the volume of air is reduced by half and also the volume of air in a single device results in arrow A>arrow A′, further reducing the cooling capacity of the entire device. To avoid this, it is necessary to prevent wind backflow and wind diffraction occurring under suction into the exhaust vent 5 as shown by the arrows B.

In techniques to address this, backflow prevention shutters 7 having the function of a check valve are provided in front of the fans as illustrated in FIG. 2A. In the normal operation of the fan, the cooling wind A is allowed to pass. As illustrated in FIG. 2B, however, if a failure occurs in the cooling fan 1-2, the backflow prevention shutter 7 provided in front of the failed fan 1-2 is closed so as to inhibit the passage of an air backflow through the exhaust vent. As a result, a flow of cooling wind as shown by the arrows A″ takes place, so that the volume of air is smaller than that of the flow shown by the arrows A, but greater than that of the flow shown by the arrow A′, decreasing the reduction in cooling capacity of the device even in the event of fan failure (A>A″>A′). The backflow prevention shutter 7 may be provided behind the cooling fan 1.

Specifically, upon detection of a fan failure, an electric shutter closes the air flow passing through the failed fan as disclosed in JP-A No. 2002-364963. However, the use of such electric shutter is not easily implemented at low cost.

JP-A No. 2003-130439 discloses a wind-pressure shutter with reduced loss of the wind pressure required for pushing up a flap by designing the flap to have front and back regions having an equal mass and a difference in area on both sides of the support shaft for a decrease in wind-pressure loss. When a failure occurs in the fan, the wind-pressure shutter returns to its original position under the weight of the flap itself, and closes the path of backflow. However, after the flap has been lifted, wind-pressure loss is produced due to the bent shape of the flap. In addition, the installation position of the wind pressure fan is limited to the vertical position.

In backflow prevention techniques in the related art, an electric shutter is not easily provided at low cost, while a wind-pressure shutter has disadvantageous problems of wind-pressure loss, limits on the installation position of a fan and the like.

### SUMMARY OF THE INVENTION

The present invention has been made in view of the above circumstances and provides a wind-pressure shutter and a cooling system which can be achieved at low cost, has little loss of wind pressure, and can allow a fan to be mounted in either the vertical direction or the horizontal direction.

A wind-pressure shutter with an air-backflow prevention function and a cooling fan system provided by the present invention do not close an airflow path under windless conditions before a device is actuated. Plural flaps provided in the wind-pressure shutter are located approximately parallel to the direction of the airflow path in order to keep the airflow path open. As a result, it is possible to reduce the loss of the wind pressure of the cooling wind passing through the shutter to near zero during the normal operation of the fan.

With a reduction in wind-pressure loss taken into consideration, the flap is desirably formed of lightweight materials such as resin, metal foil or the like. Similarly, in order to reduce the wind-pressure loss, materials with a low coefficient of friction are used for the support shaft and the bearing, and their contact surfaces are configured to be smooth with respect to each other. A reduction of components and a cost reduction can be achieved by forming the flap and the support shaft into one piece by resin molding, metal forming or the like.

The flap extends approximately parallel to the direction of the airflow path before the device is actuated, but the flap is not completely parallel and has a slight inclination. If an air-backflow from the exhaust vent occurs by a failure occurring in the fan, the flap with a slight inclination toward the airflow path receives the wind pressure of the air-backflow, thus swings about the support shaft to close the airflow path.

The flap is positioned at an angle at which the airflow path is not closed in a state before the device is actuated. This makes it possible to reduce the loss of wind pressure of the cooling wind passing through the shutter to near zero during the normal operation of the fan.

### BRIEF DESCRIPTION OF THE DRAWINGS

Preferred embodiments of the present invention will now be described in conjunction with the accompanying drawings, in which;

FIG. 1A is a plan or front view of an electronic device having plural cooling fans for illustration of the normal operation of the fans;

FIG. 1B is a plan or front view of the electronic device having plural cooling fans for illustration of the operation when a failure occurs in the fan;

FIG. 2A is a plan or front view of an electronic device having plural cooling fans and shutters for illustration of the normal operation of the fans;

FIG. 2B is a plan or front view of the electronic device having plural cooling fans and the shutters for illustration of the operation when a failure occurs in the fan;

FIG. 3 is a perspective view of a wind-pressure shutter under windless conditions;

FIG. 4 is a side view of the wind-pressure shutter under windless conditions;

FIG. 5 is a side view of a flap under windless conditions;

FIG. 6 is a side view illustrating the flap when swung to a certain point;

FIG. 7 is a side view of the flap at the time of receiving cooling wind during the operation of the fan;

FIG. 8 is a side view of the flaps when swung by receiving cooling wind during the operation of the fan;

FIG. 9 is a side view of the flap at the time of receiving an air backflow in a fan failure;

FIG. 10 is a side view of the flaps when swung by receiving an air backflow in the fan failure;

FIG. 11 is a perspective view illustrating the surface of a flap on which an air backflow is received and a force applied by the air backflow in the fan failure; and

FIG. 12 is a side view of a wind-pressure shutter under windless conditions when the shutter is mounted vertically with respect to the axis direction of the cooling fan.

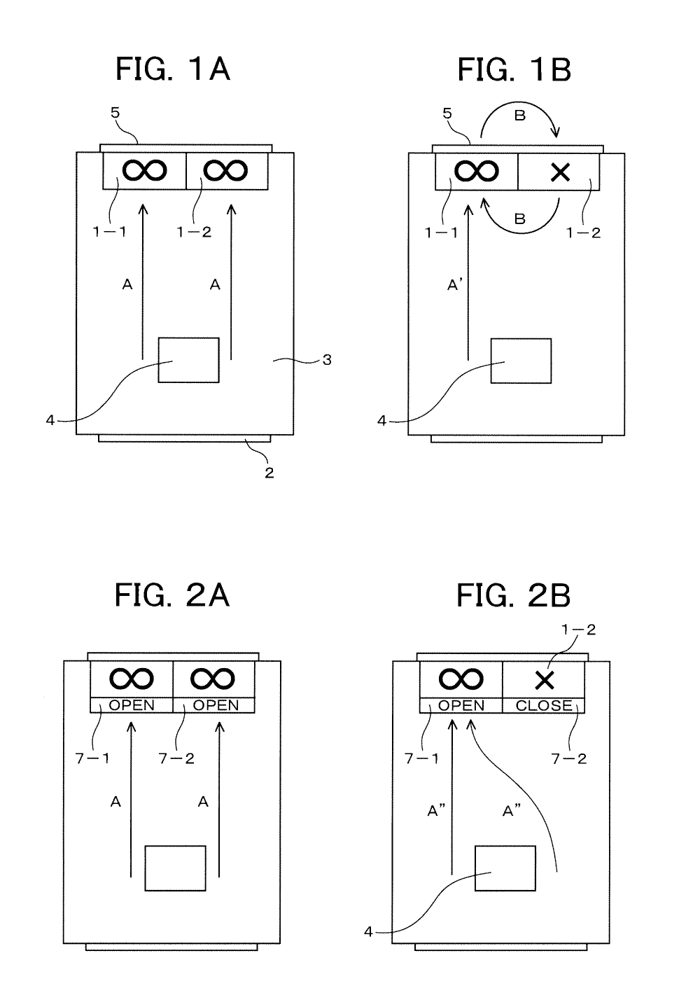

### DETAILED DESCRIPTION OF THE INVENTION

Embodiments will be described below in detail with reference to the accompanying drawings. Parts that are substantially the same are designated by the same reference numerals, and the description is not repeated.

To address the aforementioned disadvantageous problems, the embodiments provide a wind-pressure shutter which can be realized at low cost, has little loss of wind pressure, and allows a fan to be mounted in either the vertical direction or the horizontal direction.

As a result of studying the aforementioned disadvantageous problems, for example, a wind-pressure shutter blocking a backflow wind is attached to each of plural cooling fans. The wind-pressure shutter includes support shafts extending perpendicular to the exhaust direction of the cooling fan, and a flap that is capable of swinging about the support shafts and has a long portion on the exhaust side and a short portion on the intake side. The flap is swung by action of an air-backflow occurring when any cooling fan stops to close the airflow path of air passing through the failed cooling fan.

Also, in a cooling fan system including cooling fans and shutters respectively attached to the cooling fans for blocking passage of an air backflow, the shutter may include support shafts each extending substantially perpendicularly to the exhaust direction of the cooling fan, and flaps each capable of rotating about the support shafts and each having a longer portion on an exhaust side than a portion on an intake side. In this regard, the shutter rotates the flap by action of an air backflow occurring when the cooling fans stops to close an airflow path through the cooling fan.

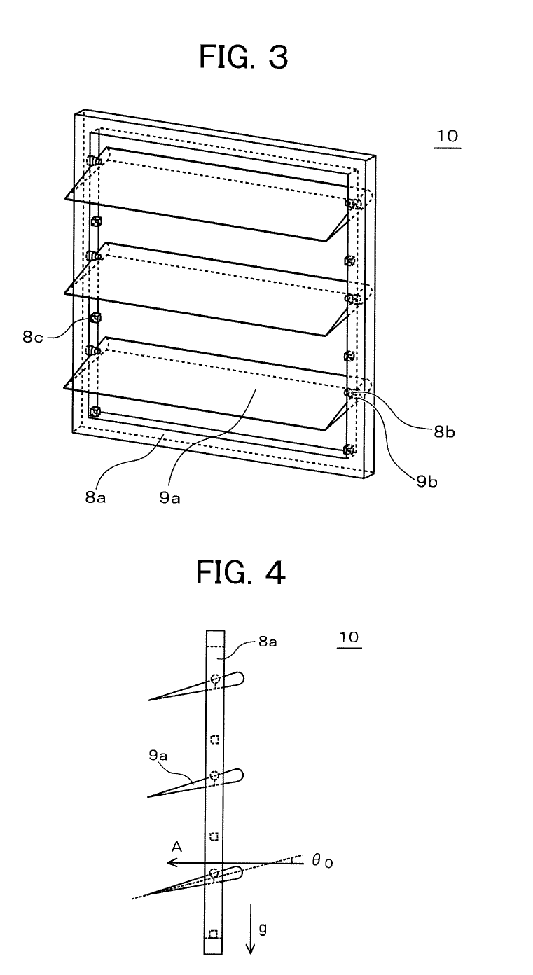

The basic structure of the wind-pressure shutter will be described with reference to FIG. 3. In FIG. 3, a wind-pressure shutter 10 includes three flaps 9a arranged in parallel and an outer frame 8a. A cylindrical support shaft 9b is attached to each of the both ends of each of the flaps 9a. The support shaft 9b is fitted into and can rotate inside a cylindrically recessed bearing 8b provided in the outer frame 8a. The embodiment uses the three flaps 9a, but numerous flaps 9a may be used based on the size of the cooling fan and the volume of air.

The state of the flaps 9a under windless conditions before the device is actuated will be described with reference to FIG. 4. In FIG. 4, each of the flaps 9a under windless conditions does not close an airflow path and keeps its balance at a small angle of θo approximately parallel to the direction A of an airflow path. The angle formed by the flap 9a and the direction A of the airflow path as shown in FIG. 4 is hereinafter defined as θ. The direction g shown in FIG. 4 is the direction of gravity and the direction A of the airflow path is assumed to be in the horizontal direction. The flap 9a under windless conditions always returns to the θo position no matter how many times it is swung, as will be described in detail later.

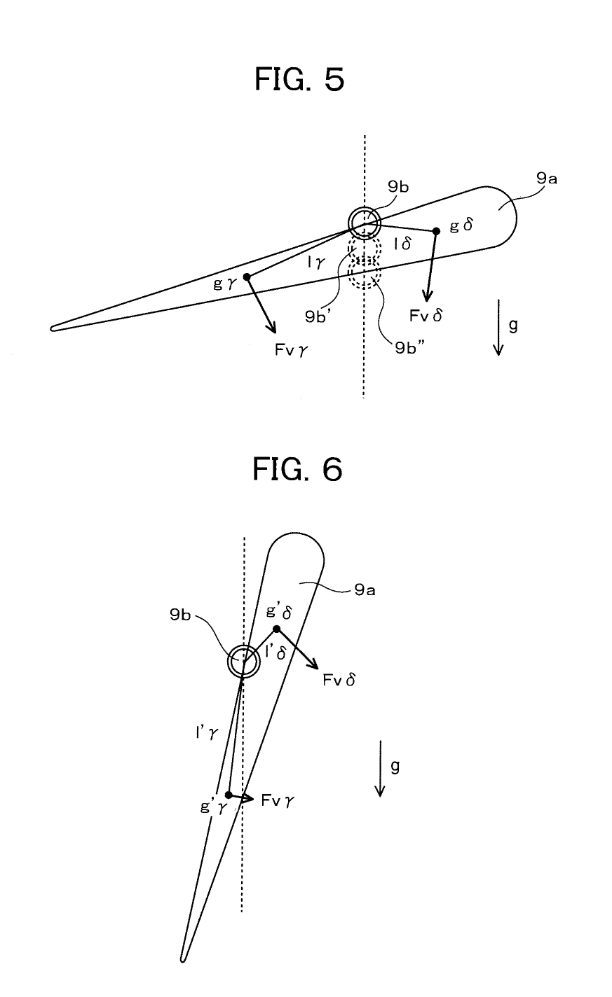

The flap 9a balances in the θo position because of its shape. The shape of the flap 9a will be specifically described with reference to FIG. 5. FIG. 5 is a side view of the flap 9a balancing in the θo position under windless conditions before the device is actuated. Assuming that the dotted line in FIG. 5 extends vertically through the center of the support shaft 9b at all times irrespective of the swinging of the flap 9a, and the flap 9a is virtually divided into two, a left portion and a right portion, on both sides of the dotted line:

the centers of gravity of the left and right portions are respectively represented as gγ, gδ;

the distances from the centers of gravity to the center of the support shaft 9b are respectively represented as lγ, lδ; and

the components, acting as moments, of the respective gravity acting on the left portion and the right portion, that is, the components perpendicular to lγ, lδ are respectively represented as Fvγ, Fvδ.

The state in which the moments that tend to produce a rotation of the flap 9a about the support shaft 9b are equal to each other can be expressed in the following equation.

Fvγ·lγ=Fvδ·lδ Equation 1

The flap 9a is formed in a shape that satisfies Equation 1, thus balancing in the position at the small angle θo.

The reason why the flap 9a tends to return to the original angle θo when it swings will be described below. The flap 9a rotates to the position in FIG. 6 from the position in FIG. 5 in which it keeps its balance at the small angle θo under windless conditions before the device is actuated. Then, the balanced moments acting on the flap 9a in FIG. 5 change to make the flap 9a unbalanced. The moments acting on the flap 9a rotating to the position in FIG. 6 will be described below.

It is assumed that:

the centers of gravity of the left and right portions on both sides of the dotted line are respectively represented as g′γ, g′δ;

the distances from the centers of gravity to the center of the support shaft 9b are respectively represented as l′γ, l′δ; and

the components, acting as moments, of the gravity acting on the left portion and the right portion, that is, the components perpendicular to l′γ, l′δ are respectively represented as fvγ, fvδ.

Then the moments that tend to produce a rotation of the flap 9a can be expressed as fvγ·l′γ, fvδ·l′δ.

For clearly describing the relationship of the magnitude between the moments fvγ·l′γ, fvδ·l′δ, we will consider how the moment factors change when the flap 9a rotates from the position in FIG. 5 to the position in FIG. 6. The rotation causes a decrease in the mass of the left portion and an increase in the mass of the right portion. As each of the directions of the respective distances l′γ, l′δ becomes parallel to the direction of gravity with the rotation of the flap 9a, the rates of the respective components fvγ, fvδ perpendicular to l′γ, l′δ derived from the gravity acting on the left portion and the right portion are decreased. In this event, since l′γ has a greater tendency to become parallel to the direction of gravity than l′δ, the decrease from Fvγ to fvγ is larger than the decrease from Fvδ to fvδ. Likewise, l′γ, l′δ are increased/decreased from lγ, lδ by the rotation of the flap 9a, but the range of the increase/decrease is much smaller than that from Fvγ, Fvδ to fvγ, fvδ, resulting in less influence on the moments. By reason of the above, the following equations hold.

fvδ·l′δ>fvγ·l′γ Equation 2

Mo=fvδ·l′δ−fvγ·l′γ Equation 3

Due to the moment Mo given by Equation 3, the flap 9a in the position in FIG. 6 will attempt to return to the original θo-degree position, that is, the position in FIG. 5. Even if the flap 9a rotates in the direction opposite to the direction of the rotation from the position in FIG. 5 to the position in FIG. 6, the flap 9a will similarly attempt to return to the position in FIG. 5.

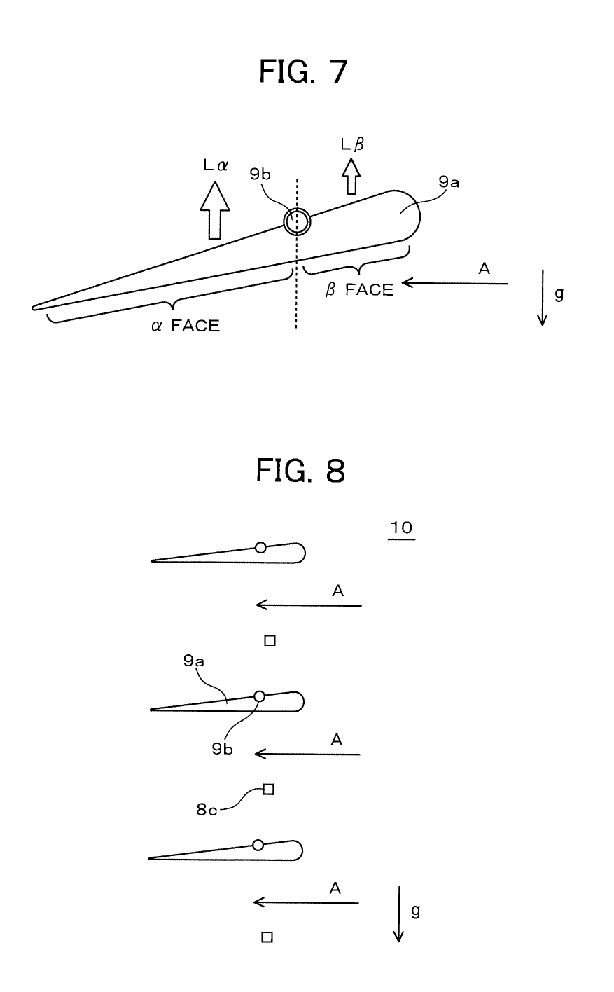

Next, a description will be given of the motion of the flap 9a when the device is actuated and the cooling fan thus produces cooling wind and an air backflow. In FIG. 7, the cooling wind flows in the direction shown by arrow A during the normal fan operation. Due to the cooling wind, wind-pressure loss corresponding to a force pushing up the flap 9a, that is, lift, is produced. However, since the degree of θo is a small angle, the wind-pressure loss is small. Also, since the flap is designed such that the α face has a larger area for receiving the wind pressure of the cooling wind than that of the β face, lift Lα is greater than lift Lβ. As a result, each flap 9a rotates in a clockwise direction to a position as shown in FIG. 8 and is positioned approximately parallel to the cooling wind.

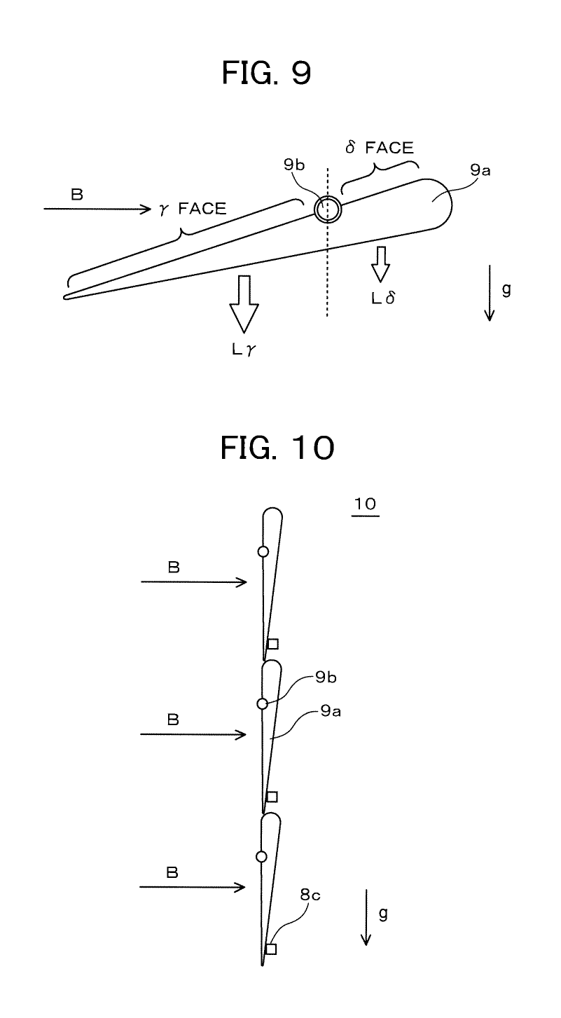

In FIG. 9, an air backflow flows in the direction shown by arrows B when a failure occurs in the cooling fan or when the cooling fan is replaced. When receiving the air backflow, since the flap 9a is not completely parallel to the wind flow, the flap 9a receives the wind pressure of the air backflow on its γ and δ faces. The γ face has a larger area for receiving the wind pressure of the air backflow than that of the δ face. For this reason, each flap 9a rotates to the position shown in FIG. 10. Even after the flap 9a has closed the airflow path, since a difference in pressure occurs between the interior and the exterior of the device, the flap 9a keeps the position closing the airflow path because of the difference in pressure. The flap 9a is not allowed to rotate beyond the position closing the airflow path (θ=90° in the embodiment) by a stopper 8c provided on the outer frame 8a.

The stopper 8c is not required to be attached to the outer frame 8a as long as it can prevent the flap 9a from rotating beyond the position closing the airflow path. A stopper may be structured to be combined with the flap 9a into one piece such that the stopper portion comes into contact with the outer frame 8a to stop the rotation of the flap 9a.

Regarding the shape of the flap, the embodiment has described a so-called teardrop type which has different thicknesses on both sides of the support shaft 9b when viewed in cross section. However, the flap may be formed in another shape as long as, on both sides of the support shaft 9b, the moments about the support shaft 9b are balanced in the θo-degree position, the area of the α face is larger than that of the β face shown in FIG. 7, and the area of the γ face is larger than that of the δ face.

The center of gravity required for calculating the moment balance can be worked out using calculations and laws, but if the shape of the flap is not simple, the center of gravity can be easily calculated by use of structure CAD software.

The position of the support shaft 9b in the thickness direction of the flap will be described below. In the embodiment, the support shaft 9b is attached to the top side of the flap 9a. However, the support shaft 9b may be attached to a portion of the flap 9a closer to the center 9b′. Although, if the support shaft 9b is located closer to the center 9b′ of the flap 9a, this reduces the force of the flap 9a in attempting to return to the original angle position when the flap 9a is swung. This is because, since lγ and lδ come closer to one straight line, the values on either side of the aforementioned Equation 2 come closer to each other.

If the position of the support shaft 9b is completely aligned with the gravity center 9b′ of the flap 9a, lγ and lδ are located on one straight line. Because of this, Equation 2 does not hold and the flap 9a does not return to the original angle after swinging. If the support shaft 9b is located on the bottom side 9b″ of the flap 9a, the flap 9a is incapable of keeping a balance in a position at a small angle of θo degrees before the device is actuated. The foregoing is effective unless the flap has a considerably complicated shape.

The description will be further simplified. Under the windless conditions, the support shaft 9b is located in an upper position at a distance R on a vertical line of the gravity center 9b′ of the flap 9a. The support shaft 9b is stable in a position where the gravity center 9b′ is in a lower position on the vertical line. When the flap 9a swings about the support shaft 9b, the gravity center 9b′ moves from the lower position on the vertical line with respect to the support shaft 9b and gives torque in the opposite direction to the flap 9a.

The value of the angle θo may be determined depending on the blast capacity of the cooling fan, the friction between the support shaft 9b and the bearing 8b, and the desired reduction in loss of wind pressure. In the embodiment, it is logically considered how to reduce the angle θo in order to achieve a wind-pressure shutter having little loss of wind pressure, and a description is given. In any case, a boundary condition is defined as “the flap 9a is swung by an air backflow so as to close the airflow path”.

There are three main types of forces applied to the flap 9a when, as a result of an air backflow, the flap 9a swings so as to close the airflow path. Strictly speaking, more types exist but are omitted here.

### (1) Force Applied to the Flap by Air Backflow

An air backflow hits the flap 9a as shown in FIG. 9, whereupon forces Lγ, Lδ act on the flap 9a.

L=½C_{L}ρν²S Equation 4

where
L is a force (lift) (N),
C_{L} is a coefficient of resistance of a pressure receiving body,
ρ is air density (kg/m³),
ν is wind speed (m/s), and
S is a pressure receiving area (m²).

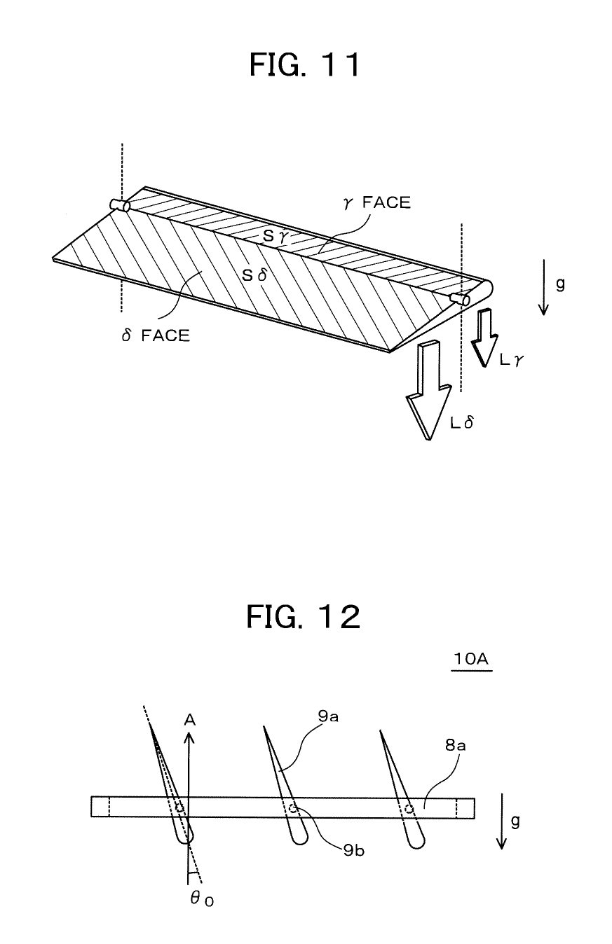

It is assumed that the area of the γ face on which the air backflow is received is Sγ and similarly the area of the δ face is Sδ (see FIG. 11) and that the forces of the air backflow received by the γ face and the δ face are Lγ, Lδ (see FIG. 11). Even when a small angle θo is set, it is necessary to form the Lγ face to be as much larger as possible than the Lδ face for fulfilling the boundary condition in which “the flap 9a is swung by an air backflow so as to close the airflow path”. That is, the area Sγ of the γ face may be designed to be as much larger as possible than the area Sδ of the δ face.

(2) Moment by which the Flap 9a Attempts to Return to θo after Swinging.

As described earlier, when the flap 9a swings, the moment fvδ·l′δ−fvγ·l′γ tending to return the flap to the original angle acts. In order to set a smaller angle θo and also meet the boundary condition in which “the flap 9a is swung by an air backflow so as to close the airflow path”, a reduction in fvδ·l′δ−fvγ·l′γ to the minimum may be recommended. This is because the flap 9a does not swing to the position to close the airflow path (θ=90 degrees in the embodiment) under the pressure of the air backflow if the moment tending to return the flap to the original angle is large, and it is therefore necessary to determine a large angle θo. As described earlier, the magnitude of the moment fvδ·l′δ−fvγ·l′γ is desirably determined to be an optimum value depending on the airflow path arrangement of the device and the blast capacity of the fan because it can be adjusted by the position of the support shaft 9b in the thickness direction of the flap. In this connection, fvδ·l′δ−fvγ·l′γ must be greater than zero in order for the flap 9a to return to the original θo-degree position.

(3) Friction Moment Occurring Between the Support Shaft 9b and the Bearing 8b when the Flap 9a Swings

Next, the dynamic friction moment M occurring when the flap 9b swings will be described, as given by the following equation.

$$M = \frac{μ Wd}{2} \qquad Equation 5$$

where
M is dynamic friction moment (mN·m),
μ is a coefficient of friction,
W is load acting on the bearing (N), and
d is a nominal bore diameter (mm).

Even when a small angle θo is set, the boundary condition in which “the flap 9a is swung by air backflow so as to close the airflow path” can be met by setting a small dynamic friction moment M. The load W acting on the bearing 8b can be reduced by reducing the mass of the flap 9a or by reducing the diameter of the support shaft 9b and using materials with a small coefficient of friction and sufficient sliding properties such as polyacetal or fluorocarbon resin, for the support shaft 9b and the bearing 8b.

The foregoing description is given of the embodiment in which a fan is installed such that the axis direction of the fan lies horizontally. Next, an embodiment, in which the wind-pressure shutter 10 is mounted such that the axis direction of the cooling fan extends vertically, will be described with reference to FIG. 12. In FIG. 12, the wind-pressure shutter 10A includes three flaps 9a arranged in parallel and an outer frame 8a. A cylindrical support shaft 9b is attached to each of the opposing ends of each flap 9a. The support shaft 9b is fitted into and can rotate inside a cylindrically recessed bearing 8b provided in the outer frame 8a. The embodiment uses the three flaps 9a, but numerous flaps 9a may be used based on the size of the cooling fan and the volume of air. The position of the support shaft 9b is different from that in the case when the fan is mounted such that the axis direction of the fan extends horizontally.

In the wind-pressure shutter 10A, as shown in FIG. 12, the shape of the flap 9a is adjusted by changing portions on both sides of the support shaft 9b in order to maintain a small angle θo at which the flap 9a is approximately parallel to the flow of the cooling wind in the vertical direction. Basically, as in the case of horizontal installation, the flap 9a before the device is actuated does not close the airflow path, resulting in just small loss of wind pressure of the cooling wind. When an air backflow occurs, the wind pressure of the air backflow is used to close the path of air-backflow.

Under the windless conditions, the support shaft 9b is located in an upper position at a distance R on a vertical line of the gravity center 9b′ of the flap 9a. That is, the distance R between the support shaft 9b and the gravity center 9b′ of the flap 9a is the same as that when the fan is installed such that the axis of the fan extends horizontally.

In any embodiment, the wind-pressure shutter can be mounted on either front or back of the cooling fan. A system including a cooling fan to which a shutter is attached is called a cooling fan system.

According to the aforementioned embodiments, it is possible to provide a wind-pressure shutter and a cooling fan system which are capable of reducing the loss of wind pressure of cooling wind passing through the shutter to near zero during normal operation of the fan because the flaps are positioned at an angle at which the airflow path is not closed in the conditions before the device is actuated. The wind-pressure loss can be reduced by selecting a light-weight material for the flap and materials and shapes for the support shaft and the bearing to reduce the friction between them. In addition, a reduction in component count and a reduction in cost can be achieved by using resin molding, metal forming or the like to form the flap and the shafts in one piece.

Since the wind pressure of an air backflow is used to close the path of the air backflow, the cooling fan can be mounted not only in the vertical direction but also in the horizontal direction.

The embodiments are effective when a failure occurs in the fan and when the fan is replaced. In addition, the advantageous effects of the embodiments include the fact that the fan can be stopped deliberately to reduce power consumption. For example, when the system architecture is small in a device of a type of adding a system depending on the usage environment or when the amount of heat liberated is small in an electronic device changed in the amount of heat liberated by a driving state, some of the plural fans can be controlled and stopped for a reduction in electric power required for the fan operation. In addition, when a temperature sensor or the like is used to detect the temperature of a heat-producing component, if the detected temperature is significantly lower than the upper limit of temperature specifications, some of the fans can be similarly stopped for a reduction in electric power.

Further, unlike an electric shutter, the backflow prevention shutter according to the embodiments is a wind-pressure shutter, which does not use electric power to control the shutter, achieving a reduction in power consumption.

What is claimed is:

1. A wind-pressure shutter for blocking an air backflow, comprising:
support shafts each extending perpendicularly to an exhaust direction of cooling fans; and
flaps each capable of rotating about the support shafts and each having a long portion on an exhaust side of the wind-pressure shutter and a short portion on an intake side of the wind-pressure shutter,
wherein the flap is rotated by an air backflow occurring when any of the cooling fans stops to close an airflow path through the stopped cooling fan.

2. The wind-pressure shutter according to claim 1, wherein the flap has a shape having an inclination toward the exhaust side in a direction that closes the airflow path through the stopped cooling fan under windless conditions.

3. The wind-pressure shutter according to claim 1, wherein the flap has a center of gravity located below the support shaft in a vertical direction under windless conditions.

4. The wind-pressure shutter according to claim 1, wherein the flap has a center of gravity located below the support shaft in a plane vertical to the support shaft under windless conditions.

5. The wind-pressure shutter according to claim 3, wherein the center of gravity of the flap is located at a distance of a predetermined value from a center of a support-shaft circle of the support shaft under windless conditions.

6. A cooling fan system, comprising:
cooling fans; and
shutters for blocking an air backflow passing through the cooling fans,
wherein each of the shutters includes support shafts each extending approximately perpendicularly to an exhaust direction of each of the cooling fans, and flaps each capable of rotating about the support shafts and each having a long portion on an exhaust side of the shutter and a short portion on an intake side of the shutter, and
each of the shutters rotates the flap by action of an air backflow occurring when the cooling fans stop to close an airflow path through the cooling fan.

7. The cooling fan system according to claim 6, wherein, when one of the cooling fans stops, the corresponding shutter rotates the flap by action of an air backflow occurring through another cooling fan to close the airflow path through the stopped cooling fan.
